(19) United States
(12) Patent Application Publication
(10) Pub. No.: US 2007/0263038 A1
(43) Pub. Date: Nov. 15, 2007

(54) Buried heater in printhead module

(76) Inventor: Andreas Bibl, Los Altos, CA (US)

Correspondence Address: FISH & RICHARDSON P.C., P.O. BOX 1022, MINNEAPOLIS, MN, 55440-1022, US

(21) Appl. No.: 11/433,162

(22) Filed: May 12, 2006

(51) Int. Cl. B41J 2/05

(52) U.S. Cl. 347/56

(57) ABSTRACT

A printhead body and method for forming a printhead body are described. The printhead body includes a body portion and a nozzle portion. The body portion includes an ink chamber. The nozzle portion includes a nozzle in fluid communication with the ink chamber in the body portion and further includes a first silicon layer, a second silicon layer, and a heater formed between the first and the second silicon layers. The nozzle extends through the first and the second silicon layers and is in fluid communication with the ink chamber.

### TECHNICAL FIELD

The following description relates to a heater included in a printhead assembly.

### BACKGROUND

An ink jet printer typically includes an ink path from an ink supply to an ink nozzle assembly that includes nozzle openings from which ink drops are ejected. Ink drop ejection can be controlled by pressurizing ink in the ink path with an actuator, which may be, for example, a piezoelectric deflector, a thermal bubble jet generator, or an electrostatically deflected element. A typical printhead has a line of nozzle openings with a corresponding array of ink paths and associated actuators, and drop ejection from each nozzle opening can be independently controlled. In a so-called “drop-on-demand” printhead, each actuator is fired to selectively eject a drop at a specific pixel location of an image, as the printhead and a printing media are moved relative to one another. In high performance printheads, the nozzle openings typically have a diameter of 50 microns or less (e.g., 25 microns), are separated at a pitch of 100-300 nozzles per inch and provide drop sizes of approximately 1 to 70 picoliters (pl) or less. Drop ejection frequency is typically 10 kHz or more.

A printhead can include a semiconductor printhead body and a piezoelectric actuator, for example, the printhead described in Hoisington et al., U.S. Pat. No. 5,265,315. The printhead body can be made of silicon, which is etched to define ink chambers. Nozzle openings can be defined by a separate nozzle plate that is attached to the silicon body. The piezoelectric actuator can have a layer of piezoelectric material that changes geometry, or bends, in response to an applied voltage. The bending of the piezoelectric layer pressurizes ink in a pumping chamber located along the ink path.

Printing accuracy can be influenced by a number of factors, including the uniformity in size and velocity of ink drops ejected by the nozzles in the printhead and among the multiple printheads in a printer. The drop size and drop velocity uniformity are in turn influenced by factors, such as the dimensional uniformity of the ink paths, acoustic interference effects, contamination in the ink flow paths, and the uniformity of the pressure pulse generated by the actuators.

### SUMMARY

A heater for use in a printhead assembly is described. In general, in one aspect, the invention features a method of forming a heater within a printhead. A first layer is formed on a silicon layer, where the silicon layer will form a nozzle portion of a printhead body. A portion of the first layer is patterned to form a desired configuration of a heater within the first layer. A metal resistor element is formed in the patterned portion of the first layer. A silicon oxide layer is provided over the patterned first layer and the metal resistor element. The silicon oxide layer and the first layer in a region is removed to form a nozzle in the nozzle portion of the printhead body. A second silicon layer is attached to the silicon oxide layer, the second silicon layer providing a body portion of the printhead body including flow paths for a printing liquid.

Implementations of the invention can include one or more of the following features. Forming the metal resistor element can include providing a metal layer over the first layer and within the pattern of the desired configuration of the heater, and removing some of the metal layer to expose the first layer. The balance of the metal layer remains within the pattern of the desired configuration of the heater and includes one or more contacts configured to electrically connect to an electrical source, said metal layer providing the metal resistor element. The desired configuration of the heater can form a serpentine like configuration. In one implementation, the serpentine like configuration includes a plurality of curved segments and curved segments located closest to an end of the heater are more closely spaced relative to one another then curved segments located toward a middle of the heater. Before removing the silicon oxide layer and the first layer to form the nozzle, the silicon oxide layer can be planarized. The first layer can be a thermal oxide layer. The metal resistor element can be formed from a nickel and chromium alloy. The metal resistor element can be formed from a copper and nickel alloy.

In general, in another aspect, the invention features a printhead body including a body portion and a nozzle portion. The body portion includes an ink chamber. The nozzle portion includes a nozzle in fluid communication with the ink chamber in the body portion and further includes a first silicon layer, a second silicon layer, and a heater formed between the first and the second silicon layers. The nozzle extends through the first and the second silicon layers and is in fluid communication with the ink chamber.

Implementations of the invention can include one or more of the following features. The nozzle portion can further include a patterned oxide layer formed on the first silicon layer and having channels therethrough, the channels defining a desired configuration of the heater within the oxide layer, and a metal layer within the channels in the oxide layer, the metal layer providing the heater and including one or more contacts configured to electrically connect to an electrical source. The second silicon layer can be a silicon oxide layer positioned over the oxide layer and the metal layer.

The desired configuration of the heater can be a serpentine like configuration. In one implementation, the serpentine like configuration includes a plurality of curved segments and curved segments located closest to an end of the heater are more closely spaced relative to one another then curved segments located toward a middle of the heater. The metal layer can be formed from various metals, including, for example, a nickel and chromium alloy or a copper and nickel alloy. The nozzle portion can further include a thermistor configured to electrically connect to a controller such that a temperature reading can be determined by the controller and a current delivered to the heater from the electrical source can be controlled.

The invention can be implemented to realize one or more of the following advantages. The heater is buried within a printhead module, thereby improving efficiency of the heater, as heat is not lost over a long conductive path. Additionally, by burying the heater within the printhead module, the printhead module can be formed more compactly.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1 shows a cross-sectional view of a portion of a printhead module.

FIG. 2 shows a top view of a portion of a printhead module.

FIG. 3 shows a cross-sectional top view of a printhead module including a buried heater.

FIGS. 4A-I show a process for forming a buried heater within a printhead module.

FIG. 5A shows an exploded view of a flexible circuit and a printhead module.

FIG. 5B shows a flexible circuit mounted on a printhead module.

FIG. 5C shows an enlarged view of a portion of the flexible circuit mounted on a printhead module shown in FIG. 5B.

FIG. 6 shows the flexible circuit mounted on a printhead module of FIG. 5B mounted within a printhead housing and attached to an external circuit.

FIG. 7 shows an enlarged view of a portion of a flexible circuit mounted on an interposer mounted on a printhead module.

### Like reference symbols in the various drawings indicate like elements.

### DETAILED DESCRIPTION

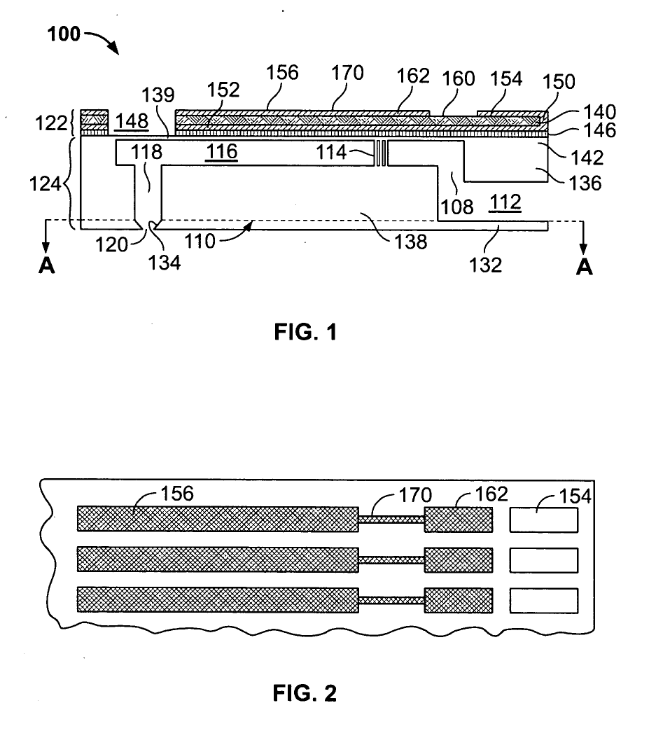

A buried heater within the silicon layers of a printhead module shall be described. FIG. 1 shows a cross-sectional view of a portion of an exemplary printhead module 100 that can be used in an inkjet printer. The buried heater can be implemented in such a printhead module, or in other configurations of printhead modules; however, for illustrative purposes, the buried heater shall be described in reference to the exemplary printhead module 100 shown.

The buried heater can be included within the printhead module 100 at an interface 110 between a nozzle portion 132 and a base portion 138. The buried heater can be used to control the temperature of a printing liquid used in the printhead module 100 by heating the components of the printhead module 100 surrounding and/or containing the printing liquid. For example, to maintain a desired viscosity of printing liquid for optimum printing conditions, the printing liquid can be warmed by the components of the printing module 100 containing the printing liquid, which components are warmed directly by the buried heater. In one implementation, the buried heater can be used in conjunction with one or more external heaters to further fine tune the temperature control.

Before describing the buried heater, an overview of the printhead module 100 shall be provided. FIG. 1 depicts a cross-sectional view through a flow path of a single jetting structure in the printhead module 100. A printing liquid enters the printhead module 100 through a supply path 112. A typical printing liquid is ink, and for illustrative purposes, the printhead module 100 is described below with ink as the printing liquid. However, it should be understood that other liquids can be used, for example, electroluminescent material used in the manufacture of liquid crystal displays or liquid metals used in circuit board fabrication.

The ink is directed by an ascender 108 to an impedance feature 114 and a pumping chamber 116. The ink is pressurized in the pumping chamber by an actuator 122 and directed through a descender 118 to a nozzle opening 120 from which ink drops are ejected. The flow path features are defined in a module body 124. The module body 124 includes a base portion 138, a nozzle portion 132 and a membrane portion 139. The base portion 138 includes a base layer of silicon, e.g., single crystal silicon. The base portion 138 defines features of the supply path 112, the ascender 108, the impedance feature 114, the pumping chamber 116 and the descender 118. The nozzle portion 132 is also formed of a silicon layer, and can be fusion bonded to the silicon layer of the base portion 138. The nozzle portion 132 defines a nozzle that can have tapered walls 134 that direct ink from the descender 118 to a nozzle opening 120. The membrane portion 139 includes a membrane silicon layer 142 that is fusion bonded to the silicon layer of the base portion 138, opposite of the nozzle portion 132.

The actuator 122 includes a piezoelectric layer 140 that has a thickness of about 15 microns. A metal layer on the piezoelectric layer 140 forms a ground electrode 152. An upper metal layer on the piezoelectric layer 140 forms a drive electrode 156. A wrap-around connection 150 connects the ground electrode 152 to a ground contact 154 on an exposed surface of the piezoelectric layer 140. An electrode break 160 electrically isolates the ground electrode 152 from the drive electrode 156. The metallized piezoelectric layer 140 is bonded to the membrane silicon layer 142 by an adhesive layer 146, e.g., a polymerized benzocyclobutene (BCB).

The metallized piezoelectric layer 140 is sectioned to define active piezoelectric regions over the pumping chambers 116. In particular, the metallized piezoelectric layer 140 is sectioned to provide an isolation area 148. In the isolation area 148, piezoelectric material is removed from the region over the descender. This isolation area 148 separates arrays of actuators on either side of a nozzle array.

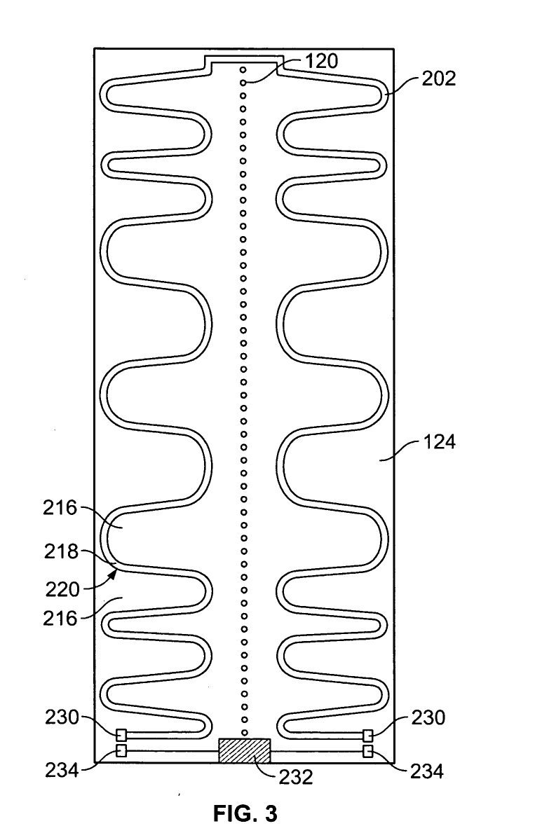

Referring to FIG. 2, a top view of a portion of the printhead module 100 illustrates a series of drive electrodes 156 corresponding to adjacent flow paths. Each flow path has a drive electrode 156 connected through a narrow electrode portion 170 to a drive electrode contact 162 to which an electrical connection is made for delivering drive pulses. The narrow electrode portion 170 is located over the impedance feature 114 and reduces the current loss across a portion of the actuator 122 that need not be actuated. Multiple jetting structures can be formed in a single printhead module, e.g., to provide a 300-nozzle printhead module. The ground electrodes 154 on the piezoelectric layer are shown.

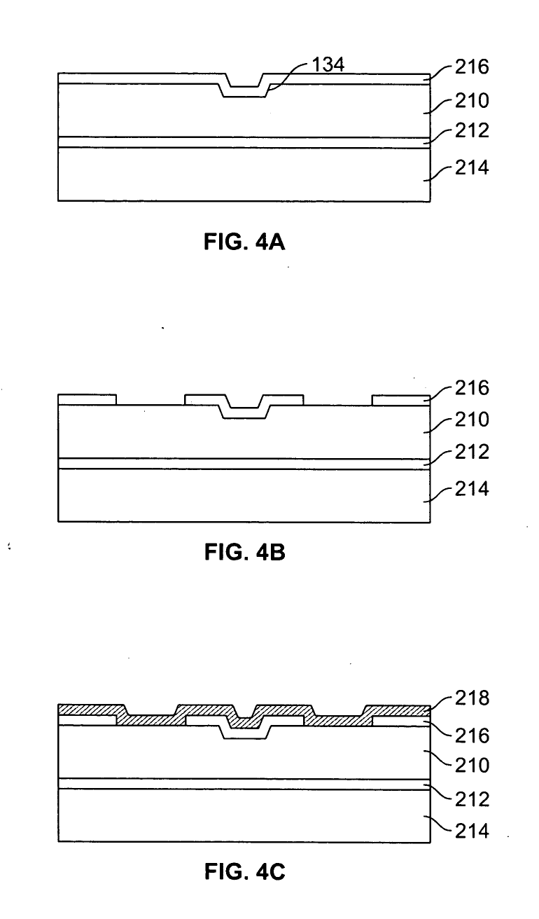

FIG. 3 is a cross-sectional plan view of the module body 124 taken along line A-A of FIG. 1. A row of nozzles 120 is shown, where a nozzle corresponds to the nozzle 120 shown in side view in FIG. 1. Although not shown, the flow paths for adjacent nozzles in the row can alternate between extending toward opposite edges of the module body. The buried heater 202 is depicted in a serpentine-like configuration, with higher density towards the ends of the module body 124. The configuration of the buried heater 202 is for illustrative purposes; other configurations are possible. In one embodiment, the buried heater 202 is formed from a layer of nichrome deposited in the desired configuration, e.g., a serpentine-like configuration as shown. The density of the buried heater towards the ends of the module body 124 is increased as heat loss increases with the increased surface area at the comers of the module body 124. The buried heater 202 is layered between and surrounded by two layers of silicon; a bottom layer being the nozzle portion 132 and the upper layer being adjacent to the base portion 138 of the module body 124.

A thermistor 232 can be included in the module body 124 to indicate the temperature of the printhead module 100, thus giving an indication of the temperature surrounding the ink. In the embodiment shown, the thermistor 232 is included at an end of the module body 124 at the same layer as the buried heater 202. In other embodiments, the thermistor 232 can be included at other locations within the module body 124.

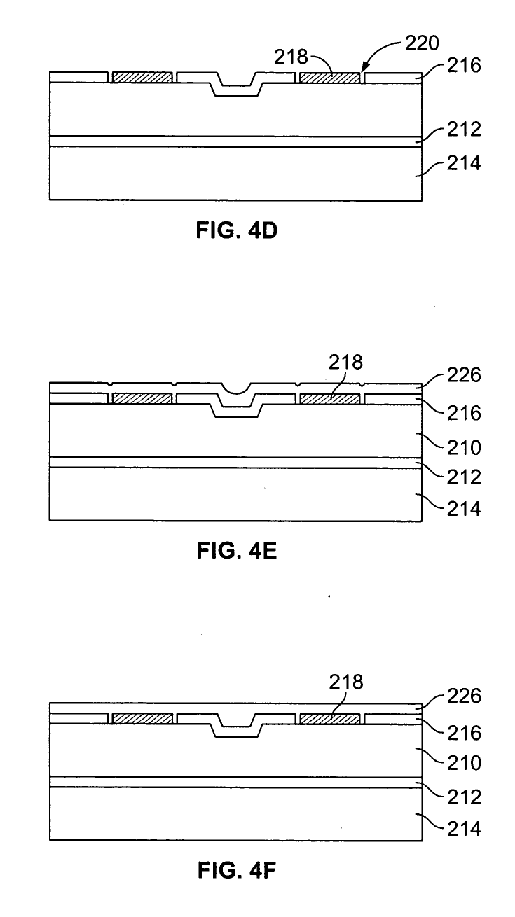

FIGS. 4A-I show a cross-sectional side view of a piece of the nozzle portion 132 during the manufacture of the buried heater 202 in the proximity of the illustrative nozzle 120 shown in FIG. 1. In this implementation, the silicon layer 210 that will ultimately form the nozzle portion 132 has been etched to form the tapered walls 134 of the nozzle 120; the actual nozzle opening has not yet been formed. For manufacturing purposes, the silicon layer 210 can be part of a silicon-on-insulator substrate that includes an oxide layer 212 that can be formed on the lower surface of the silicon layer 210 and a “handle” silicon layer 214. A thermal oxide layer 216 is formed on the upper, etched surface of the silicon layer 210. The thickness of the thermal oxide layer 216 should be selected to match the thickness of a metal layer that will be deposited in a later step to form the buried heater.

Referring to FIG. 4B, the thermal oxide layer 216 is etched to pattern the desired buried heater configuration. The thermal oxide layer 216 can be etched by an inductively coupled plasma reactive ion etching (ICP RIE) process, although other techniques can be used. Next, referring to FIG. 4C, the selected metal, e.g., a nickel and chromium alloy, such as Nichrome®, is used to metallize the upper surface of the patterned thermal oxide layer 216 and exposed silicon layer 210. Other metals can be used, for example, Constantant®, a copper and nickel alloy (Cu55/Ni45). The metal layer 218 is patterned, e.g., by photolithographic etching, to remove metal on the thermal oxide layer 216, such that the remaining metal is within the trenches formed within the thermal oxide layer 216. Referring to FIG. 4D, small gaps 220 between the metal layer 218 and thermal oxide layer 216 may be created for tolerances during patterning. A silicon oxide layer 226 is deposited on top of the patterned metal and thermal oxide layers 218, 216, as shown in FIG. 4E. In one implementation, the silicon oxide layer can be deposited by plasma enhanced chemical vapor deposition (PECVD).

Referring to FIG. 4F, the upper surface of the silicon oxide layer 226 is planarized, for example, by chemical mechanical polishing, to form a smooth, planar surface. A smooth surface can ensure a good bond and eliminate small differences in height created between the thermal oxide 216 and the metal layer 218. Referring to FIG. 4G, the nozzle 120 is exposed by stripping the oxide layers deposited over the etched area in the previous steps. Referring to FIG. 4H, the upper surface of the silicon oxide layer 226 can be attached to a silicon wafer that will be used to form the base portion 138 of the module body 124, or to an already formed base portion 138. Referring to FIG. 41, the handle layer 214 can be removed and the silicon layer 210 ground to expose the nozzle opening.

Referring again to FIG. 3, the buried heater 202 is formed from the metal layer 218 and is surrounded on all sides by thermal oxide 216. The entire surface depicted in FIG. 3 is coated with the silicon oxide layer 226 (not shown), as was described in reference to FIGS. 4E-I.

The buried heater 202 receives electrical signals at contacts 230. In one implementation, the contacts 230 can be formed from nichrome and optionally a second metallization layer can be added to the contacts 230, for example, a layer of gold. In one implementation, the electrical signals can be received from an integrated circuit mounted on a flexible circuit attached to the printhead module 100. The integrated circuit receives electrical signals from an external circuit, for example, a circuit controlled by a processing unit of a printer in which the printhead module 100 is operating. The flexible circuit upon which the integrated circuit is mounted can be the same flexible circuit that provides electrical connections to the drive electrodes 156 described above in reference to FIG. 1. That is, an external circuit can be connected to one or more integrated circuits on the flexible circuit to provide drive signals to the drive electrodes, as well as to provide input signals to the buried heater, and to receive feedback from the thermistor 232 to control the temperature thereof.

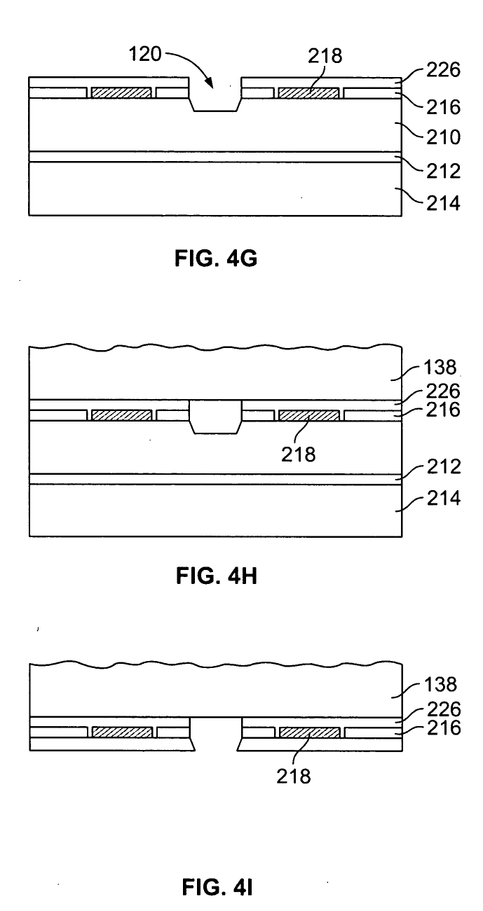

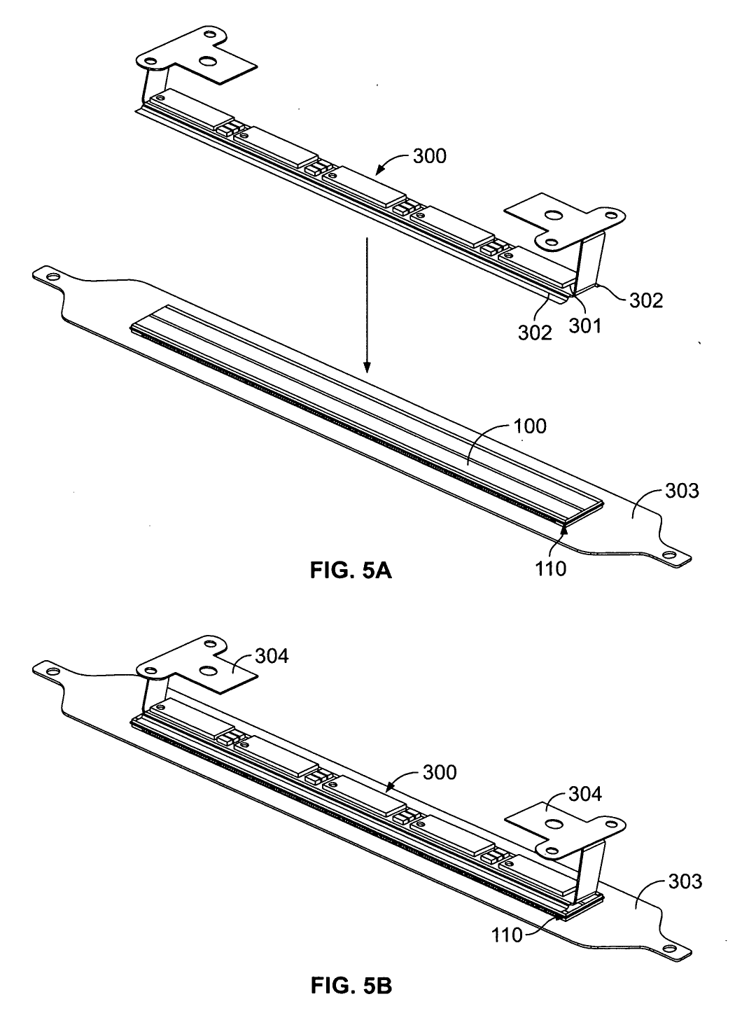

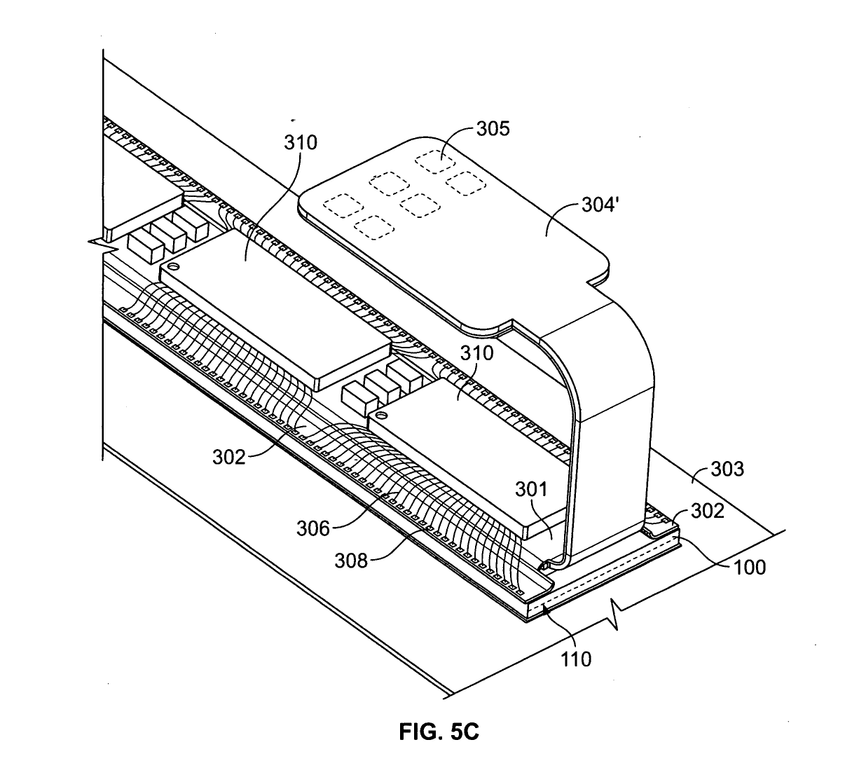

FIGS. 5A and 5B show one embodiment of a flexible circuit 300 that can be mounted onto the printhead module 100 to provide electrical connections to the actuators 122 and the buried heater 202. This embodiment of a flexible circuit is described in further detail in U.S. patent application Ser. No. 11/119,308, filed Apr. 28, 2005, entitled “Flexible Printhead Circuit”, the entire contents of which are hereby incorporated by reference. The flexible circuit 300 has a gull-wing structure, including a main central portion 301 with distal portions 302 extending the length of the flexible circuit 300. The central portion 301 and distal portions 302 are joined by bent portions that extend at an angle between the central and distal portions, providing clearance between the bottom surface of the central portion 301 and the upper surface of the printhead module 100. The clearance allows the piezoelectric material on the upper surface of the printhead module 100 to flex when actuated. The printhead module 100 is shown mounted on a faceplate 303.

Referring to FIG. 5C, integrated circuits 310 are affixed to the upper surface of the central portion of the flexible circuit 300. Flexible circuit leads 306 are shown extending from each integrated circuit 310 to corresponding apertures 308 formed in the distal portions 302 of the flexible circuit 300. A flexible circuit lead 306 is provided for each ink nozzle included in the printhead module 100. The flexible circuit lead 306 transmits a signal from the integrated circuit 310 to an activator that activates the ink nozzle. For example, in this embodiment, the flexible circuit lead 306 transmits an electrical signal to activate a piezoelectric actuator to fire an ink nozzle.

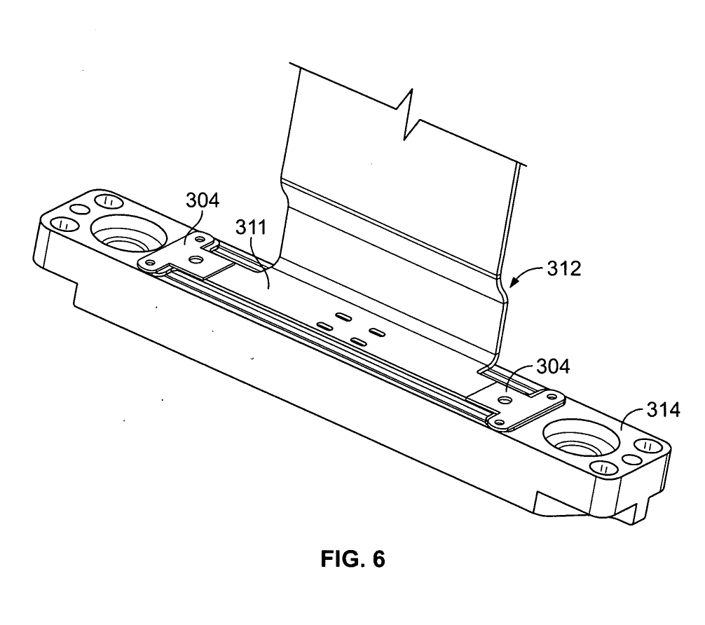

On either end of the flexible circuit 300 an arm 304′ extends upwardly in a direction substantially perpendicular to the surface of the faceplate 302 upon which the printhead module 100 is mounted and folds over, such that the distal end of the arm 304′ is substantially parallel to the surface of the faceplate 302. External connectors 305 (shown in phantom) are included on the underside of the distal end of the arm 304′. The arm 304′ shown in FIG. 5C is a different, alternative configuration to the arm 304 shown in FIGS. 5A, 5B and 6. However, the configuration shown in FIGS. 5A, 5B and 6 can be used, as well as differently configured arms.

Referring to FIG. 6, the flexible circuit 300 mounted on the printhead module 100 is shown mounted within a printhead housing 314. An external circuit 312 is electrically connected to the flexible circuit 300. The external connectors 305 of the flexible circuit 300 are configured to mate with connectors on a connection plate 311 of the external circuit 312. In one embodiment, the external connectors 305 are ball pads that electrically connect to traces on the surface of the connection plate 311. In another embodiment, the external connectors are male or female electrical connectors. The external circuit 312 can connect to a controller that transmits and receives signals to and from the printhead module 100 via the flexible circuit 300. For example, the controller can be a processor in a printer within which the printhead module 100 is implemented.

The flexible circuit 300 includes one or more connective layers extending the length of the flexible circuit 300, including the arms 304. The connective layers are electrically connected to at least one of the electrical connectors 305 formed on the distal ends of the arms 304. Input signals from the external circuit 312 are transmitted from the external circuit 312 via the one or more connective layers to the integrated circuits 310. Electrical signals then transmit from the integrated circuits 310 to the printhead module 100, including the buried heater 202, via the leads 306 and apertures 308.

Referring again to FIG. 5C, the buried heater 202 is included within the printhead module 100 approximately at the location indicated by the dashed line representing the interface 110 between the nozzle portion 132 and the base portion 138 of the module body 124. One or more leads 306 from an integrated circuit 310 mounted on the flexible circuit 300 can connect via one or more apertures 308 to the buried heater 202. For example, the apertures 308 connecting to the buried heater 202 can extend to the buried heater 202 (but not beyond), where the metallized inner surface of the apertures can electrically connect to the contacts 230 of the buried heater 202 to provide an electrical connection to the buried heater 202. For example, referring again to FIG. 3, the electrical connections can be made from the flexible circuit 300 to the contacts 230 of the buried heater 202 to provide a current through the buried heater 202.

An electrical connection can be made from the flexible circuit 300 to the thermistor 232. In the embodiment shown, a lead 306 extends from an integrated circuit 310 on the flexible circuit 300 to a metallized aperture 308. The metallized aperture 308 electrically connects to contacts 234 that are electrically connected to the thermistor 232. The thermistor 232 is used to measure the temperature in the vicinity of the thermistor 232 and is connected to external circuitry for this purposes via contacts 234. The temperature reading from the thermistor 232 can be sent to a controller (in this implementation, external to the printhead), to control the current provided to the buried heater 202, thereby controlling the temperature of the ink.

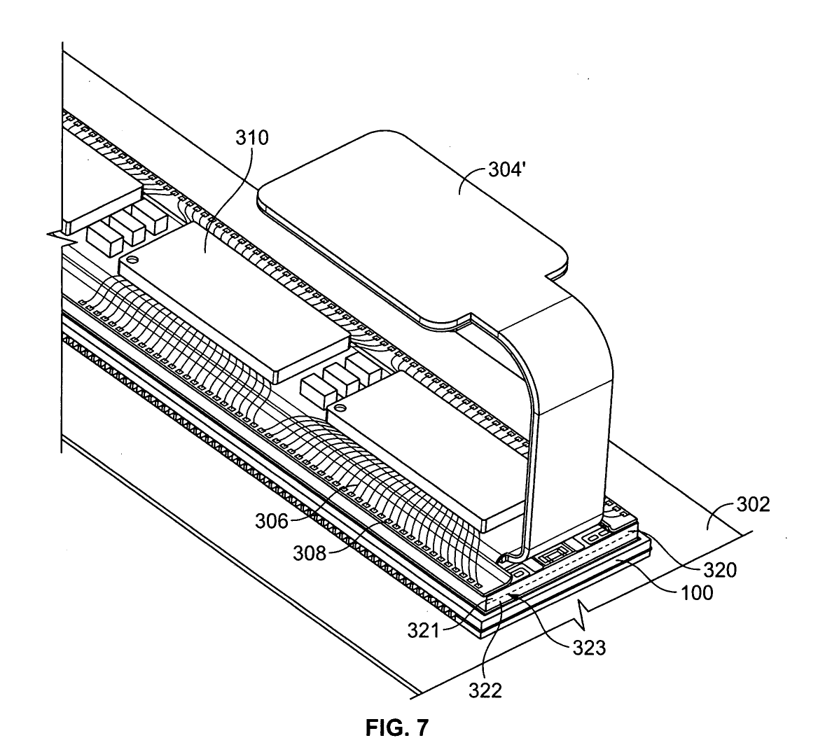

Referring to FIG. 7, an alternative embodiment is shown that includes an interposer 320 positioned between the flexible circuit 300 and the printhead module 100. An enlarged view of a portion of the interposer 320 mounted on the printhead module 100 is shown. The interposer 320 includes apertures along both sides that align to apertures 308 formed in the flexible circuit 300. The apertures are coated with a conductive material, such as gold. One aperture corresponds to each ink nozzle included in the ink nozzle assembly of the printhead module 100. A signal can thereby travel from an integrated circuit 310, through a flexible circuit lead 306 to a conductive aperture 308 in the flexible circuit 300, to a conductive aperture in the interposer 320, and finally to an ink nozzle activator in the printhead module 100. The interposer 320 can be attached to the printhead module using a thin epoxy, such that when pressure and heat is applied, the gold connects through the epoxy to connectors on the printhead module 100. The epoxy can be unfilled or filled, such as a conductive particle filled epoxy. The epoxy can be a spray-on epoxy.

In one implementation, the buried heater 202 can be included in the interposer 320 rather than the printhead module 100. That is, the interposer can be formed between an upper portion 321 and a lower portion 322, with the buried heater 202 located at the interface 323 between the upper and lower portions 321, 322. The thermistor 232 can be included on the interposer 320 to control the temperature. The buried heater 202 and thermistor 232 can be electrically connected to the flexible circuit 300 in a similar manner as described above. In this implementation, the heater 202 is still buried within the printhead module 100, even though included in an interposer. The arm 304′ has a configuration the same as the arm shown in FIG. 5C, but alternatively can be configured differently, for example, as the arm 304 shown in FIGS. 5A, 5B and 6.

The use of terminology such as “upper” and “lower” and “top” and “bottom” throughout the specification and claims is for illustrative purposes only, to distinguish between various components of the buried heater and other elements described herein. The use of “upper” and “lower” and “top” and “bottom” does not imply a particular orientation of the buried heater. For example, the upper surface of the silicon layer 210 described herein can be orientated above, below or beside a lower surface, and vice versa, depending on whether the silicon layer 210 is positioned horizontally face-up, horizontally face-down or vertically.

Although only a few embodiments have been described in detail above, other modifications are possible. Other embodiments may be within the scope of the following claims.

What is claimed is:

1. A method of forming a heater within a printhead, comprising:
forming a first layer on a silicon layer, the silicon layer to form a nozzle portion of a printhead body;
patterning a portion of the first layer to form a desired configuration of a heater within the first layer;
forming a metal resistor element in the patterned portion of the first layer;
providing a silicon oxide layer over the patterned first layer and the metal resistor element;
removing the silicon oxide layer and the first layer in a region to form a nozzle in the nozzle portion of the printhead body; and
attaching a second silicon layer to the silicon oxide layer, the second silicon layer providing a body portion of the printhead body including flow paths for a printing liquid.

2. The method of claim 1, wherein forming a metal resistor element comprises:
providing a metal layer over the first layer and within the pattern of the desired configuration of the heater; and
removing some of the metal layer to expose the first layer, the metal layer remaining within the pattern of the desired configuration of the heater and including one or more contacts configured to electrically connect to an electrical source, said metal layer providing the metal resistor element.

3. The method of claim 1, wherein the desired configuration of the heater comprises a serpentine like configuration.

4. The method of claim 3, wherein the serpentine like configuration includes a plurality of curved segments and curved segments located closest to an end of the heater are more closely spaced relative to one another then curved segments located toward a middle of the heater.

5. The method of claim 1, further comprising:
before removing the silicon oxide layer and the first layer to form the nozzle, planarizing the silicon oxide layer.

6. The method of claim 1, wherein the first layer is a thermal oxide layer.

7. The method of claim 1, wherein the metal resistor element is formed from a nickel and chromium alloy.

8. The method of claim 1, wherein the metal resistor element is formed from a copper and nickel alloy.

9. A printhead body comprising:
a body portion including an ink chamber;
a nozzle portion including a nozzle in fluid communication with the ink chamber in the body portion, the nozzle portion comprising:
a first silicon layer,
a second silicon layer, and
a heater formed between the first and the second silicon layers;
where the nozzle extends through the first and the second silicon layers and is in fluid communication with the ink chamber.

10. The printhead body of claim 9, the nozzle portion further comprising:
a patterned oxide layer formed on the first silicon layer and having channels therethrough, the channels defining a desired configuration of the heater within the oxide layer; and
a metal layer within the channels in the oxide layer, the metal layer providing the heater and including one or more contacts configured to electrically connect to an electrical source;
where the second silicon layer comprises a silicon oxide layer positioned over the oxide layer and the metal layer.

11. The printhead body of claim 10, wherein the desired configuration of the heater comprises a serpentine like configuration.

12. The printhead body of claim 11, wherein the serpentine like configuration includes a plurality of curved segments and curved segments located closest to an end of the heater are more closely spaced relative to one another then curved segments located toward a middle of the heater.

13. The printhead body of claim 10, wherein the metal layer is formed from a nickel and chromium alloy.

14. The printhead body of claim 10, wherein the metal layer is formed from a copper and nickel alloy.

15. The printhead body of claim 9, wherein the nozzle portion further comprises:
a thermistor configured to electrically connect to a controller such that a temperature reading can be determined by the controller and a current delivered to the heater from the electrical source can be controlled.
